(19) United States
(12) Patent Application Publication
(10) Pub. No.: US 2024/0382995 A1
(43) Pub. Date: Nov. 21, 2024

(54) DEVICE FOR SPRAYING AND DISTRIBUTING LIQUID

(71) Applicant: JANOSEVIC Sasa, Wien (AT)

(72) Inventor: Sasa Janosevic, Wien (AT)

(21) Appl. No.: 18/695,685

(22) PCT Filed: Sep. 27, 2022
(86) PCT No.: PCT/AT2022/060332

§ 371 Date: Mar. 26, 2024

(30) Foreign Application Priority Data
Sep. 27, 2021 (AT) A 60251/2021

(51) Int. Cl. B05B 15/65; B05B 1/18; B05B 17/08

(52) U.S. Cl. CPC B05B 15/65; B05B 1/185; B05B 17/08

(57) ABSTRACT

The invention relates to a device (1) for spraying and distributing liquid, having at least one connection element (8) for connecting to a liquid connection and at least one dispensing opening (3) for dispensing liquid. The present device addresses the problem of improving the known devices. This problem is solved in that the connection element (8) is arranged in a base element (5) of the device (1), said base element (5) being adjoined by a cover element (2) in which the at least one dispensing opening (3) is arranged, wherein the cover element (2) and base element (5) enclose at least one channel (4) which fluidically connects the connection element (8) to the at least one dispensing opening (3), wherein, between the cover element (2) and base element (5), at least one seal (5, 6) is provided which forms a boundary of the channel (4) in a radial direction over the entire height of the channel (4).

The invention relates to a device for spraying and distributing liquid having at least one connection element for connection to a liquid connection and at least one dispensing opening for dispensing liquid.

In this context, a device for spraying and distributing liquid means, for example, a device for adiabatic cooling, e.g. for floor cooling. Furthermore, such a device can be used to generate spray mist, fountains and the like. This can provide cooling in parks or squares and at the same time serve as an eye-catcher.

A nozzle is known from KR 101656064 B1 that can be used to generate spray mist. A cover is arranged on a base element which, together with the base element, forms a small gap through which the water flows out at high speed. When the nozzle is not in use, it is flush with the floor. When water flows through the nozzle, the cover with the base element is moved out of the floor in the direction of the water flow. As the jet of water hits the cover, the cover is lifted and moves upwards. The water exits through the resulting gap and is deflected by the cover and finely distributed in the surrounding area.

This nozzle can be used to cool the ground on terraces, for example. The resulting spray mist cools the ground around this nozzle due to the evaporation of the water when it gets hot.

The disadvantage of this application is the possible interference caused by a weight acting on the cover. This means that the function can be disrupted by people or objects standing on the nozzle. Dirt or ageing phenomena and damage can also prevent the cover from moving and thus disrupt its function.

The shape of the spray mist depends largely on the speed at which the jet hits the cover and the movement of the cover. This means that the nozzle is very limited in its functionality.

Due to the shape, some liquid remains in the nozzle after the water supply is switched off. As a result, germs can multiply in the remaining water and cause an unpleasant odor.

It is the object of the present invention to eliminate the disadvantages of the prior art and to provide an improved device for spraying and distributing liquid.

This object is solved in accordance with the invention in that a base element and a cover element are provided, which can be connected to one another in a force-fit and/or form-fit manner, wherein the connection element is arranged in the base element, and the cover element and base element enclose at least one channel, the connection element and the at least one dispensing opening are flow-connected to one another, wherein at least one seal is provided between the cover element and the base element, which forms a boundary of the channel in the radial direction over an entire height of the channel, and wherein the at least one dispensing opening is arranged in the region of the at least one cover element.

A base element is understood here to be the base of the device which, together with the connection element, has the connection for supplying liquid, in particular water, and provides the base body for distributing the liquid.

In this context, a cover element is a cover that combines a design element with a technical function. Ideally, the cover element provides a flat finish for the device with a floor, ceiling or wall element surrounding the device, such as a patio floor panel.

Water is usually used as the liquid. However, the device is not limited to the use of water, but can also be used for operation with any suitable liquid.

The channel, which is closed off by the seal and the cover and base element, reduces the liquid-carrying volume to a minimum. The channel ensures an even distribution of the liquid in the device. Due to the narrowness of the channel and the small dimensions of the liquid-carrying areas in the base element or cover element, deposits are avoided due to the prevailing high flow velocities. Impurities are removed through the dispensing openings due to the high flow velocities. After the water supply is switched off, the volume filled with water is small and can evaporate completely more quickly when hot, which prevents unpleasant odors from the device.

It is advantageous if two seals are provided as two mutually opposite boundaries of the channel. This can increase the tightness of the device against the environment.

It is advantageous if the seal or seals have essentially circular sealing surfaces, because round shapes lead to better sealing and therefore also to less leakage of the device due to the higher accuracy that can be achieved.

The device is particularly cost-effective and easy to manufacture if the seal or seals for limiting the channel are designed as O-rings.

Assembly and disassembly, as well as cleaning and repair, are easier if the cover element and base element are screwed together, for example by means of an internal and external thread on the cover and base element and/or using screws.

It is particularly advantageous if the at least one dispensing opening is designed as a bore in the cover element, into which at least one nozzle can be arranged. Interchangeable nozzles make it possible to achieve a wide range of spray patterns without having to make changes to the basic concept of the device. This increases cost-effectiveness with maximum flexibility.

It is advantageous if at least one dispensing opening is designed as an indentation between the cover element and the base element.

It is particularly advantageous if a plurality of indentations is regularly distributed around a circumference.

A particularly advantageous embodiment of the device according to the invention provides that at least one dispensing opening is provided as a gap between the base element and the cover element. A circular spray pattern can be achieved through this gap, which ensures an even distribution of the liquid around the device.

In order to guarantee good atomization, it is advantageous if the gap has a width of less than or equal to 0.5 mm and preferably between 0.2 and 0.5 mm.

Particularly simple production can be achieved if the gap between the cover element and the base element is essentially annular.

In order to achieve a distance that is as constant as possible and thus a uniform droplet size of the liquid, it is advantageous if the gap is interrupted by shoulders, preferably regularly distributed around the circumference.

In order to achieve a good compromise between uniform droplet size distribution and surface coverage, it is advantageous to make the shoulders as narrow as possible, wherein it is advantageous if the shoulders have a width of less than 0.5 mm and are provided on the cover element or base element, wherein the base element or cover element rests against the shoulder or shoulders of the respective other component.

A favorable structure from a flow perspective is achieved if the channel opens into the gap at at least one boundary wall, with the channel preferably opening into the gap over essentially its entire circumference.

In order to achieve the largest possible area with spray mist, it is advantageous if the indentation or gap extends along a surface that is at least partially inclined to the axis of rotation or vertical axis, wherein the axis of rotation or vertical axis and the surface form an angle of between 40° and 80°.

In order to achieve the smoothest possible transition between the individual areas in the device for the liquid and to avoid detachment, it is advantageous if the base element is curved towards the cover element to form the gap.

In order to prevent leaks and consequential damage from leaks towards the bottom, i.e. towards a possible substrate, it is advantageous if a seal is arranged on an outer casing of the device, preferably between the cover element and the base element.

For easy and precise assembly, it is advantageous if the cover element and base element each have a chamfer relative to one another on an outer casing of the device, in which a seal is preferably arranged.

For a large-area and uniform distribution of the water, it is advantageously provided in one embodiment that the dispensing opening has an inclination to a vertical axis of the device that is inclined radially outwards by between 15 and 25°.

For favorable and simple production, it is provided that the cover element and the base element are essentially designed as bodies of rotation about an axis of rotation.

A particularly advantageous embodiment of the device provides that a receptacle is provided into which a foam bubbler and/or a headlamp and/or a nozzle can be inserted in a receptacle, wherein the receptacle is preferably arranged coaxially to an axis of rotation of the device.

It is advantageous if the connection element extends at least as far as the channel and the connection element preferably terminates flush with a boundary wall of the channel.

It is particularly advantageous if the connection element is flow-connected to the channel via a bore.

It is advantageous if the channel has a first boundary wall in a normal plane to the axis of rotation and the channel preferably forms a circular ring in this normal plane.

In order to ensure a flow transition that is as loss-free as possible, one particular embodiment variant provides for a ratio of a flow cross-section of the connection element to a channel cross-section of between 0.8 and 1.2.

In order to achieve favorable flow conditions, it is provided in a particular embodiment that the axis of the connection element is arranged parallel and preferably eccentrically to the axis of rotation of the device, wherein the connection element is preferably arranged on a radius that essentially corresponds to the center radius of the channel.

The center radius is the sum of the radius and half the width of the channel, wherein the radius extends from the axis of rotation of the device to the radially inner boundary wall.

It is advantageous if the at least one dispensing opening on the cover element is arranged on a side of the device opposite to and facing away from the connection element.

It is advantageous if at least one nozzle is arranged in the cover element, the axis of rotation of which is aligned parallel to an axis of rotation of the connection element, and which is preferably connected to the channel via a coaxial bore.

A practical and favorable embodiment is created if at least three nozzles are provided, which are arranged offset by 120° on the circumference, wherein the nozzles are preferably arranged on a radius that corresponds to a center radius of the channel.

In the embodiment according to the invention, no moving elements are required for full function, and the cover element can be designed to be simple and practically flush with surrounding floor, ceiling or wall elements. This makes the device particularly robust and resistant to faults.

The invention is explained below in more detail with reference to non-limiting embodiments in the figures, wherein:

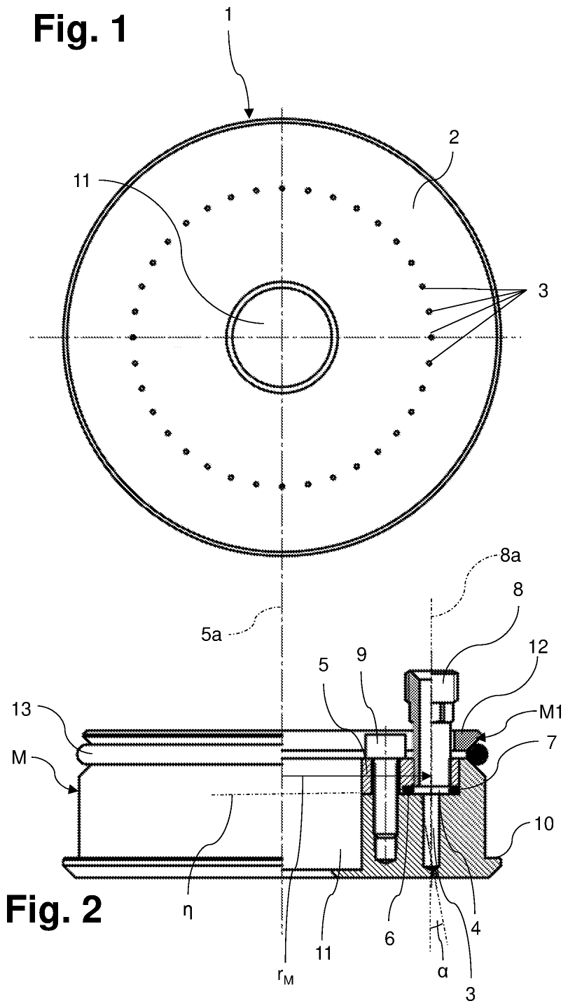

FIG. 1 shows a first view of a first embodiment of a device according to the invention;

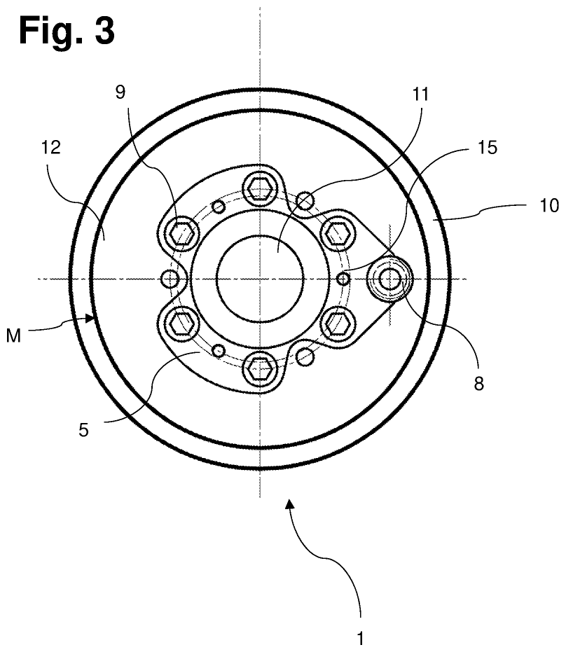

FIG. 2 shows a side view of the first embodiment in half section;

FIG. 3 shows a second view of the first embodiment;

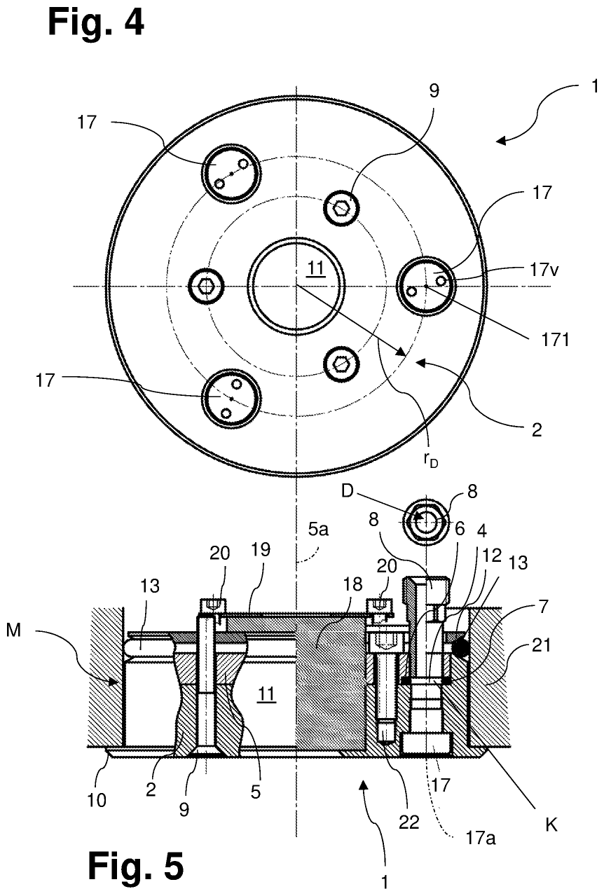

FIG. 4 shows a first view of a second embodiment of a device according to the invention;

FIG. 5 shows a side view of the second embodiment in half section with cut-out;

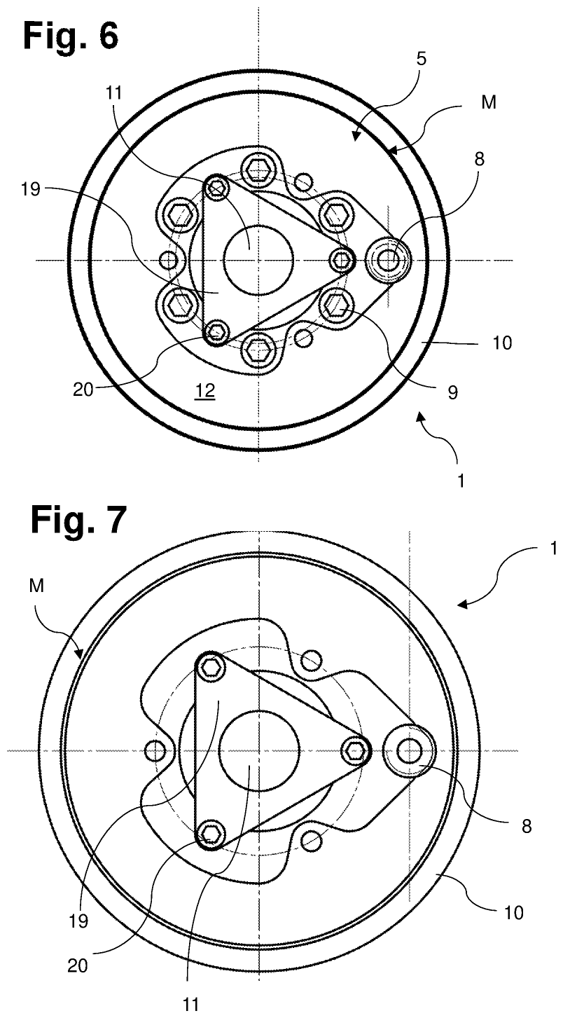

FIG. 6 shows a second view of the second embodiment;

FIG. 7 shows a first view of a third embodiment of a device according to the invention;

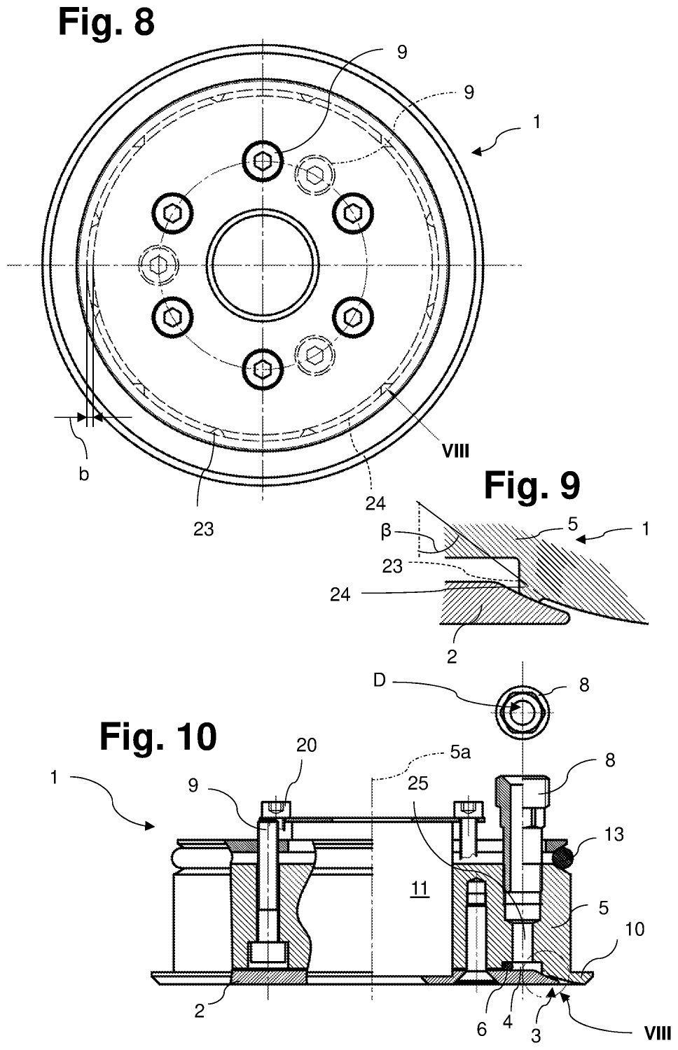

FIG. 8 shows a second view of the third embodiment;

FIG. 9 shows a detail VIII of the third embodiment according to FIG. 8;

FIG. 10 shows a side view of the third embodiment in half section with cut-out,

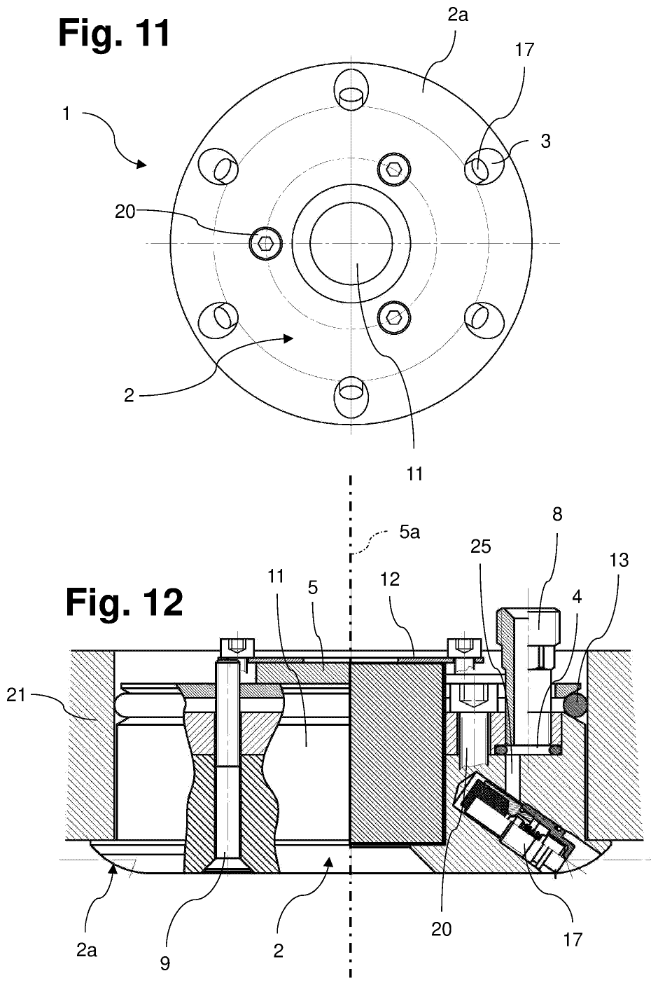

FIG. 11 shows a first top view of a fourth embodiment of the invention,

FIG. 12 shows a side view of the fourth embodiment in half section with cut-out, and

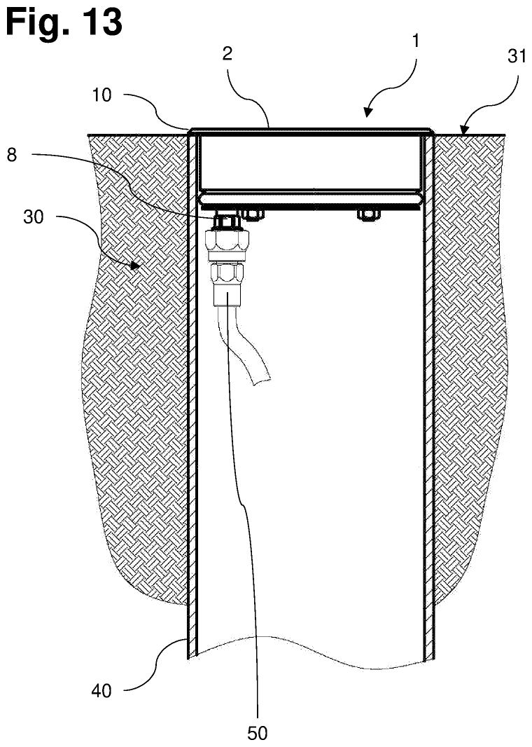

FIG. 13 shows a schematic sectional view of the device according to the invention from FIG. 1 in the installation position.

FIG. 1 shows a first embodiment of a device 1 according to the invention. A cover element 2 can be seen, which has several dispensing openings 3. These dispensing openings 3 lead to a channel 4, which can be seen in the half section in FIG. 2. The channel 4 is bounded by the underside of the cover element 2 and a base element 5 as well as an inner O-ring 6 and an outer O-ring 7. In the assembled state, the underside of the cover element 2 faces the upper side of the base element 5.

The designations inner and outer O-ring 6, 7 refer to the position in relation to an axis of rotation 5a of the base body of the base element 5 and the base body of the cover element 2, which each have a rotationally symmetrical shape if bores and screwed-in elements are not taken into account.

The channel 4 is provided in all embodiments of the device 1 according to the invention. In its simplest embodiment, it can extend as a channel 4 with an elongated and straight extension between base element 5 and cover element 2 and connect at least two dispensing openings 3 to each other. In the more advantageous embodiments shown in the figures, the channel 4 has a circular ring shape and connects all the dispensing openings 3 to each other across the entire device 1. Furthermore, the channel 4 connects the dispensing openings 3 to the at least one connection element 8, which can connect the device to a liquid connection, which is not shown here, however.

The channel 4 is intended for distributing the liquid to the dispensing openings 3. The connection element 8, which is designed to be rotationally symmetrical here, opens with its axis of rotation 8a in the area of a central radius r_{M} of the channel 4. A flow direction of the channel 4 extends on average normal to the flow direction from the connection element 8. Ideally, the central flow direction is parallel to a normal plane n to the axis of rotation 5a of the base element 5. A surface between the cover element 2 and the base element 5 is also designed parallel to the normal plane η. In this embodiment, the channel 4 also has two boundary walls parallel to the normal plane η.

A liquid connection for connection to the connection element 8 is not shown in the figures and is also not part of the device 1 according to the invention, but the connection element 8 can be connected to such a liquid connection.

The cover element 2 is fixed to the base element 5 with screws 9. In the embodiment shown, these screws 9 are screwed in from a side of the device 1 facing away from the cover element 2.

The cover element 2 has a shoulder 10, which is intended for arrangement in a corresponding recess in a wall element not shown further, or in a ceiling element or in a floor element. The cover element 2 is designed to be flush with the surrounding wall element in the most favorable form, while the base element 5 is arranged entirely in a polocal tube, for example, which is installed in the floor, the ceiling or the wall.

In a recess 11 coaxial to the axis of rotation 5a of the device 1, for example, a foam bubbler, a spotlight or a rotatable ball with a through bore can be provided, which can be pivoted relative to the device 1. Liquid or water can be fed through the bore of this ball and emitted as a jet.

In an alternative embodiment, the above-mentioned recess 11 can also be arranged eccentrically. More than one recess can also be provided.

Reference number 12 denotes a disk that is arranged on the underside of the base element 5, namely on the side facing away from the cover element 2, and has a chamfer on an outer casing M1 towards the cover element 2. The cover element 2 also has a chamfer towards the disk 12 on its outer casing M. A further seal 13 is arranged in the space formed by these two chamfers. Alternatively, the disk 12 can be firmly connected to the base element 5 or the base element 5 itself can have the chamfer towards the cover element 2.

The disk 12 is pulled in the direction of the cover element 2 using the screws 9. This squeezes the seal 13 and presses it outwards away from the outer casing M, thereby enlarging its circumference and protruding beyond the outer casing M of the cover element 2. This achieves maximum tightness and improved hold in an intended mounting opening, for example formed by a polocal tube, in the ceiling, wall or floor element.

FIG. 2 shows that the dispensing openings 3 are designed as bores with a very small diameter, for example between 0.4 and 1 mm. These bores have an inclination of an angle α of approximately 0° to 60° to an axis parallel to the axis of rotation 5a. Here, the axes of the bores intersect the axis of rotation 5a and are inclined radially outwards by the angle α.

FIG. 3 shows a bottom view of the device according to the invention, in which it can be seen that the outer circumference of the disk 12 corresponds to that of the base element 5, while the outer circumference of the cover element 2 is significantly larger, so that the shoulder 10 is formed. The screws 9 serve to firmly connect base element 5 and cover element 2 to each other so that they cannot be forced apart by the pressure acting in channel 4.

Further possible embodiments with associated figures are explained below. Only the differences to the other embodiments will be discussed. Elements with the same function have the same reference signs as in the previous version.

FIG. 4 shows a second embodiment of the device 1 according to the invention, in which the dispensing openings 3 are formed by nozzles 17. In an exemplary embodiment, an outlet opening 171 of the nozzle 17 has a diameter of several hundred micrometers. The three nozzles 17 are arranged on a radius r_{D} and are aligned along an axis of rotation 17a of the nozzle 17. In the simplest case, the axes of rotation 17a of the nozzles 17 are aligned parallel to the axis of rotation 5a. In alternative embodiments, the axes of rotation 17a can also be inclined. The nozzles 17 are designed here as vandal-proof nozzles. Recesses for a vandal key are indicated by reference sign 17v. In the context of this disclosure, “vandal-proof nozzles” are understood to mean nozzles that are protected against vandalism and destruction and can only be removed from the cover element 2 with the aid of a special key.

A recess 11 is again provided concentrically on base element 5 and cover element 2. Similar to the first embodiment, a freely selectable element 18 can be arranged in this recess 11.

If the recess 11 is unused, a cover 19 is provided to protect the recess 11 from soiling. This cover 19 can be used alternatively or additionally to fix an element 18 in the recess 11. It can also be provided, for example, that light elements, such as light-emitting diodes, are arranged in recesses in the cover element 2, which are protected against the liquid distributed by the device by means of suitable glass cover elements.

Base element 5 and cover element 2 are again connected with screws 9, but in this embodiment, these are fastened from the cover element 2.

The cover 19 is fixed to the base element 5 with additional screws 20. The connection element 8 is shown in FIG. 5 in section, uncut and in a top view. The connection element 8 extends up to the channel 4.

As can be seen in FIG. 5, the shoulder 10 of the device 1 rests on a wall, floor or ceiling element 21 when mounted.

The seal 13 lies between two chamfers on the outer casing M, M1 and prevents water or other liquid from penetrating behind the floor, wall or ceiling element 21. The seal 13 is squeezed by tightening screws 9 and the device 1 is held in position and clamped in a mounting opening.

FIG. 7 to FIG. 10 show a third version of the device 1. In contrast to the other embodiments, indentations 23 are provided as dispensing openings between the cover element 2 and the base element 5 for a liquid. For this purpose, the base element 5 has indentations 23, for example in the form of milled recesses, on its upper side facing the cover element 2, while the cover element 2 and the base element 5 rest on each other at elevations 24 between the indentations 23, which can be seen in particular in FIG. 9. Alternatively, it may also be provided that the indentations 23 are arranged on the underside of the cover element 2 facing the base element 5.

In this embodiment of the invention, a bore 25 connects the channel 4 and the connection element 8 to each other. The channel 4 leads radially outwards to the indentations 23, which here form the dispensing openings 3. A seal 6 is only required radially on the inside of the channel 4.

The indentation 23 has a width with respect to its radial extension along the device 1 which corresponds to approximately 0.5 mm or less, whereby a pump is required to convey the liquid for bores with a width of 5 hundredths of a millimeter to several hundredths of a millimeter. For widths of a few tenths of a millimeter, the device can be operated with a line pressure of a few bar (approx. 5 bar±2 bar).

FIG. 9 shows that a surface of the device 1, which has the indentation 23, is inclined by an angle β relative to the axis of rotation 5a. This angle β is between 40° and 80°.

In another embodiment, not shown in the figures, the dispensing opening 3 is designed as a gap that is interrupted by shoulders. FIG. 8 with its indentations 23 can be understood as a negative of the gap with its shoulders. The gap can also be designed without interruptions, and thus essentially circular, so that this gap acts as the only dispensing opening in the area of the cover element for the liquid.

FIGS. 11 and 12 show a further variant of the device 1 according to the invention, in which nozzles 17 are again arranged on the cover element 2, but their installation position is inclined to the axis of rotation 5a. The angle α can preferably be between 3° and 60°. This variant is successfully used, for example, for floor surface cooling, wherein working pressures of 50 to 120 bar are common, while the mist height is desirably less than 1 m.

The outer edge area 2a of the cover element 2 has a radius of 30 mm, for example, in order to accommodate the nozzles 17. To make it easier to install the nozzles 17, the nozzle head has a polygonal shape so that the nozzle 17 can be turned into the intended receptacle using a suitable wrench. The nozzle 17 is supplied with fluid in the manner described above, with a bore 25 acting as a connection between channel 4 and nozzle 17.

FIG. 13 shows an example of the installation of the device 1 according to the invention in a floor as a water spray element. Here, a polocal tube 40 is inserted into a base 30, which is flush with a floor surface 31. A liquid connection 50 is attached to the base element 5 of the device according to the invention, which is in liquid connection with the connection element 8 and subsequently with the channel 4.

With this installation method, the shoulder 10 of the cover element 2 rests on the floor surface 31. Due to the low height of the shoulder 10 of a maximum of 3 mm and a chamfer or radius 2a on the outer edge of the cover element 2, the device 1 according to the invention protrudes only slightly above the floor surface 31, so that tripping is extremely unlikely due to the device 1 being arranged in the floor 30.

A significant advantage of the device according to the invention is its simple modular design consisting essentially of two turned parts, namely the base element 5 and the cover element 2, which can be quickly and easily connected to one another. The device 1 can also be easily and flexibly adapted to different requirements. For example, different elements can be inserted into the receptacle 11 of the device 1 according to the invention, such as lighting elements consisting of an RGB light-emitting diode insert, or other liquid-supplying elements such as a foam bubbler, which preferably has its own liquid supply, independent of the liquid supply to the nozzles 17. The nozzles 17 themselves can be of different designs depending on the area of application. For example, low-pressure nozzles, classic water jet nozzles or high-pressure nozzles can be used. It is also possible for a light element to be arranged in at least one dispensing opening and for the liquid to be dispensed via an element arranged in the holder 11, such as a water nozzle or a foam bubbler.

1. Device (1) for spraying and distributing liquid, having at least one connection element (8) for connection to a liquid connection and at least one dispensing opening (3, 23) for dispensing liquid, characterized in that a base element (5) and a cover element (2) are provided, which can be connected to one another in a force-fit or form-fit manner, wherein the connection element (8) is arranged in the base element (5), and wherein the cover element (2) and the base element (5) enclose at least one channel (4) which fluidically connects the connection element (8) and the at least one dispensing opening (3, 23) to one another, wherein at least one seal (5, 6) is provided between the cover element (2) and the base element (5), which seal forms a boundary of the channel (4) in the radial direction over an entire height of the channel (4), and wherein the at least one dispensing opening (3, 23) is arranged in the region of the at least one cover element (2).

2. Device (1) according to claim 1, characterized in that two seals (5, 6) are provided as two mutually opposite boundaries of the channel (4), wherein the seals (5, 6) have essentially annular sealing surfaces and are preferably designed as O-rings.

3. Device (1) according to claim 1 or 2, characterized in that the cover element (2) and base element (5) can be connected to one another via an internal thread and an external thread arranged on the cover element (2) and base element (5) or via screws (9).

4. Device (1) according to one of claims 1 to 3, characterized in that the at least one dispensing opening (3) is designed as a bore in the cover element (2), in which at least one nozzle (17) can be arranged.

5. Device (1) according to one of claims 1 to 3, characterized in that the at least one dispensing opening (3) is designed as at least one indentation (23) between the cover element (2) and the base element (5), wherein the at least one indentation (23) has a width (b) which is less than or equal to 0.5 mm and preferably between 0.2 and 0.5 mm.

6. Device (1) according to claim 5, characterized in that a plurality of indentations (23) are regularly distributed over a circumference.

7. Device (1) according to one of claims 1 to 3, characterized in that at least one dispensing opening (3) is formed as a gap between the base element (5) and the cover element (2), which preferably extends substantially annularly between the cover element (2) and the base element (5).

8. Device (1) according to claim 7, characterized in that the gap has a width (b) which is less than or equal to 0.5 mm and preferably between 0.2 and 0.5 mm.

9. Device (1) according to one of claim 7 or 8, characterized in that the gap is interrupted by shoulders, preferably regularly distributed around the circumference.

10. Device (1) according to claim 9, characterized in that the shoulders have a width of less than 0.5 mm and are provided on the cover element (2) or base element (5), wherein the base element (5) or cover element (2) rests against the shoulder or shoulders of the respective other component.

11. Device (1) according to one of claims 7 to 10, characterized in that the channel (4) opens into the gap at at least one boundary wall, wherein the channel (4) preferably opens into the gap essentially over an entire circumference.

12. Device (1) according to one of claims 5 to 11, characterized in that the gap and/or the at least one indentation (23) extends along a surface which is at least partially inclined to the axis of rotation (5a) or to the vertical axis, wherein the axis of rotation (5a) or vertical axis and the surface enclose an angle (B) of between 40° and 80°.

13. Device (1) according to one of claims 7 to 12, characterized in that the base element (5) is curved towards the cover element (2) to form the gap.

14. Device (1) according to one of claims 1 to 13, characterized in that—preferably between cover element (2) and base element (5)—a seal (13) is arranged on an outer casing (M) of the device (1).

15. Device (1) according to one of claims 1 to 14, characterized in that the cover element (2) and the base element (5) each have a chamfer relative to one another on an outer casing (M) of the device (1), in which chamfer a seal (13) is preferably arranged.

16. Device (1) according to one of claims 1 to 15, characterized in that the at least one dispensing opening (3) has an inclination (a) to a vertical axis or axis of rotation (5a) of the device (1), which is inclined radially outwards by between 15° and 25°.

17. Device (1) according to one of claims 1 to 16, characterized in that the cover element (2) and the base element (5) are essentially designed as bodies of rotation about an axis of rotation (5a).

18. Device (1) according to one of claims 1 to 17, characterized in that a receptacle (11) is provided into which a foam bubbler and/or a headlamp and/or a nozzle can be inserted, wherein the receptacle (11) is preferably arranged coaxially to an axis of rotation (5a) of the device (1).

19. Device (1) according to one of claims 1 to 18, characterized in that the connection element (8) extends at least as far as the channel (4), and in that the connection element (8) preferably terminates flush with a boundary wall of the channel (4).

20. Device (1) according to one of claims 1 to 18, characterized in that the connection element (8) is flow-connected to the channel (4) via a bore (25).

21. Device (1) according to one of claims 1 to 20, characterized in that the channel (4) has a first boundary wall in a normal plane (n) to the axis of rotation (5a) and the channel (4) preferably forms a circular ring.

22. Device (1) according to one of claims 1 to 21, characterized in that a ratio of a flow cross-section (D) of the connection element (8) to a channel cross-section (K) is between 0.8 and 1.2.

23. Device (1) according to one of claims 1 to 22, characterized in that the axis (8a) of the connection element (8) is arranged parallel and preferably eccentrically to the axis of rotation (5a), wherein the connection element (8) is preferably arranged on a radius which essentially corresponds to the center radius (r_{M}) of the channel (4).

24. Device (1) according to one of claims 1 to 23, characterized in that the at least one dispensing opening (3) on the cover element (2) is arranged on a side of the device (1) opposite to and facing away from the connection element (8).

25. Device (1) according to one of claims 1 to 24, characterized in that at least one nozzle (17) is arranged in the cover element (2), the axis of rotation (17a) of which is aligned parallel to an axis of rotation (8a) of the connection element (8) and which is preferably connected to the channel (4) via a coaxial bore.

26. Device (1) according to one of claims 1 to 25, characterized in that at least three nozzles (17) are provided, which are arranged offset by 120° on the circumference, wherein the nozzles (17) are preferably arranged on a radius (r_{D}) which corresponds to a center radius (r_{M}) of the channel (4).
